(19) United States
(12) Patent Application Publication
(10) Pub. No.: US 2013/0335298 A1
(43) Pub. Date: Dec. 19, 2013

(54) NOTIFICATION METHOD

(71) Applicants: Sergey Karmanenko, St. Petersburg (RU); Igor Mikhnenko, Kharkov (UA); Dmitry Alekseevich Gorilovsky, St. Petersburg (RU)

(72) Inventors: Sergey Karmanenko, St. Petersburg (RU); Igor Mikhnenko, Kharkov (UA); Dmitry Alekseevich Gorilovsky, St. Petersburg (RU)

(73) Assignee: YOTA DEVICES IPR LTD., Tortola (VG)

(21) Appl. No.: 13/876,622

(22) PCT Filed: Sep. 13, 2011
(86) PCT No.: PCT/RU2011/000701

§ 371 Date: Sep. 3, 2013

(30) Foreign Application Priority Data
Sep. 28, 2010 (GB) 1016288.1
Oct. 20, 2010 (GB) 1017776.4
Dec. 10, 2010 (GB) 1020999.7
Jul. 20, 2011 (GB) 1112461.7

(51) Int. Cl. G06F 3/14

(52) U.S. Cl. CPC G06F 3/1446
USPC 345/1.3

(57) ABSTRACT

Method of providing notification messages on a bar form factor display device operating at low power, the bar form factor display device comprising front and back major faces, the front major face arranged to present a first display screen and the back major face arranged to present a second display screen different to the first display screen, wherein the second display screen is a bi-stable display screen, comprising the steps of: i) Executing software on the device, the software operating the device in a low power notification mode in which the first display screen is off and in which the device is operable to receive a notification message; ii) The software on the device receiving a notification message; iii) Displaying the notification message on the bi-stable display screen.

### BACKGROUND OF THE INVENTION

1. Field of the Invention

The field of the invention includes methods of providing notification messages in a bar form factor display device at low power, especially bar form factor display devices comprising a plurality of display screens. Bar form factors include slab, slate, block, bar and candybar.

2. Technical Background

Bar form factor display devices, eg. slate devices such as the iPhone™ and the iPad™, are known. However, these devices comprise only a single display screen. A bar form factor device may be a slate device.

3. Discussion of Related Art

In US2008002115A1, as shown in prior art FIG. 3, there is disclosed a display stack-up 300 which is provided for a mobile electronic device 100 having an internal and external display, for example a clamshell style mobile phone. The display stack-up comprises a backlight unit 114 and an external display device 110 having bi-stable optical states. The external display device 110 is placed in contact with, and is optically coupled to, the backlight unit 114. The display stack-up further comprises an internal display device 106 which is placed in contact with, and is optically coupled to, the external display device 110.

The terms “internal display” and “external display” employed in US2008002115A1 arise because the device disclosed therein contains a hinged part such that one display is permanently visible to a user (the “external display”), while the other display may or may not be visible to a user (the “internal display”). Prior art FIG. 4 is disclosed in US2008002115A1. In US2008002115A1 it is disclosed that the mobile electronic device 100 includes a first housing member 102 and a second housing member 104. The first housing member 102 and the second housing member 104 may be made up of materials like metal, plastic, glass and/or hybrids thereof. The first housing member 102 and the second housing member 104 are hingedly connected with one another and are configurable in the open and closed positions. In other words, the first housing member 102 and the second housing member 104 are connected to each other with a hinge such that the angle between the two is approximately 180° or less, when configured in an open position, and the minimum angle is approximately 0° or slightly greater, when configured in the closed position. The first housing member 102 further comprises an external display aperture 101 and an internal display aperture 103 through which the external display device 110 and internal display device 106 are viewable, respectively. The display itself comprises three primary devices which are encased by the first housing member 102. In the cross sectional view of prior art FIG. 4, the three devices are shown in a “stack-up” configuration having the internal display device 106, the external display device 110, and a backlight device 108.

Prior art FIG. 5 taken from US2008002115A1 shows the hinged mobile phone disclosed therein in the closed configuration. In the closed configuration the inner display surface is protected from scratching which may occur eg., when the device is inside a woman's handbag and it comes into contact with various items such as keys, make up casing and metal elements on the surface of a money holder. The closed configuration is more compact than the open configuration of prior art FIG. 4; the compactness is useful when the device is being transported, eg. in a woman's handbag, because its greatest lateral extent is reduced with respect to the open configuration. The interface components are kept inside the hinged phone, which offers more surface area when the device is open than when the device is closed. Interface components such as keypad keys and an internal display are protected when the device is closed, and when closed it is less long or wide, making the device easier to carry around. When a hinged phone is in the closed configuration, the second display can be used for display purposes because the first display may not be visible in the closed configuration.

The device of prior art FIGS. 4 and 5 is not a bar form factor device because it consists of two parts connected by a hinge.

### SUMMARY OF THE INVENTION

According to a first aspect of the invention, there is provided a method of providing notification messages on a bar form factor display device operating at low power, the bar form factor display device comprising front and back major faces, the front major face arranged to present a first display screen and the back major face arranged to present a second display screen different to the first display screen, wherein the second display screen is a bi-stable display screen, comprising the steps of:

i) Executing software on the device, the software operating the device in a low power notification mode in which the first display screen is off and in which the device is operable to receive a notification message;

ii) The software on the device receiving a notification message;

iii) Displaying the notification message on the bi-stable display screen.

The method may be one in which notification messages are from a notification message provider.

The method may comprise the step of: the software on the device receiving a notification message from a notification message provider.

The method may comprise the step of: the software determining if the notification message is a new notification message, and the bi-stable display screen is updated only if the notification message is a new notification message.

The method may be one in which the notification message is displayed on the bi-stable display screen at a low screen update frequency.

The method may be one in which the notification message comprises an image.

The method may be one in which the notification message comprises text.

The method may be one in which an application or service executing on the device is able to display a notification message on the second screen.

The method may be one in which any application or service executing on the device is able to display a notification message on the second screen.

The method may be one in which notification message display time is not limited, because a bi-stable display is used.

The method may be one in which a notification message remains on the back screen after a step in which the device itself is switched off.

The method may be one in which the second screen comprises an E-ink bi-stable display.

The method may be one in which the second screen comprises Electronic Paper Display under glass.

The method may be one in which the second screen uses interferometric modulation display technology.

The method may be one in which a first display resolution is similar to a second display resolution.

The method may be one in which the second screen provides approximately at least 1000 full screen updates using 300 mAh of charge for a screen size of approximately 4 inches.

The method may be one in which the second screen update rate is the order of twice per minute.

The method may be one in which the notification message is of one or more categories, the categories including one or more of news, social messages, an emergency notification, financial news, earthquake, tsunami or weather.

The method may be one in which a notification message is a social network message provided on a social network screen.

The method may be one in which the notification message is a social network message provided on a Facebook page.

The method may be one in which a notification message is a social message provided by a social messaging service.

The method may be one in which a notification message is a social message provided by a social networking service.

The method may be one in which the notification message is of one or more categories, wherein the categories are preselected.

The method may be one in which the categories are preselected by a user.

The method may be one in which the categories are preselected by a network services provider.

The method may be one in which the notification message is text message from a blog site.

The method may be one in which the notification message is privacy controlled.

The method may be one in which a maximum screen update frequency is a user settable parameter in the software.

The method may be one in which the device is portable.

The method may be one in which the device is a mobile phone, a portable digital assistant, a laptop, a digital audio player (eg. ipod), or a tablet computer (eg. ipad).

The method may be one in which the device includes a virtual keyboard.

The method may be one in which the device comprises a touch screen.

The method include the step of changing the skin of the bi-stable display screen.

The method may be one in which the step of changing the skin of the bi-stable display screen comprises providing a skin which is one or more of: wallpaper, photos, movies, or user-customized content.

The method may include the step of providing context-related content on the bi-stable display screen.

The method may be one in which the step of providing context-related content on the bi-stable display screen includes providing location-based advertising.

The method may be one in which the step of providing context-related content on the bi-stable display screen includes providing results of a location-based search.

According to a second aspect of the invention there is provided a computer program product operable to provide notification messages on a bar form factor display device operating at low power, the bar form factor display device comprising front and back major faces, the front major face arranged to present a first display screen and the back major face arranged to present a second display screen different to the first display screen, wherein the second display screen is a bi-stable display screen, the computer program product when running on the bar form factor display device operable to provide the steps of:

i) The computer program product operating the device in a low power notification mode in which the first display screen is off and in which the device is operable to receive a notification message;

ii) The computer program product on the device receiving a notification message;

iii) The computer program product displaying the notification message on the bi-stable display screen.

### BRIEF DESCRIPTION OF THE DRAWINGS

FIG. 1 shows the front face and back face of an example device of the invention in the same Figure. The device is shown in the off state.

FIG. 2 shows the front face and the back face of an example device of the invention in the same Figure. The device is shown in the on state.

FIG. 3 is from the prior art publication US2008002115A1. In this Figure there is disclosed a display stack-up 300 which is provided for a mobile electronic device 100 having an internal and external display, for example a clamshell style mobile phone.

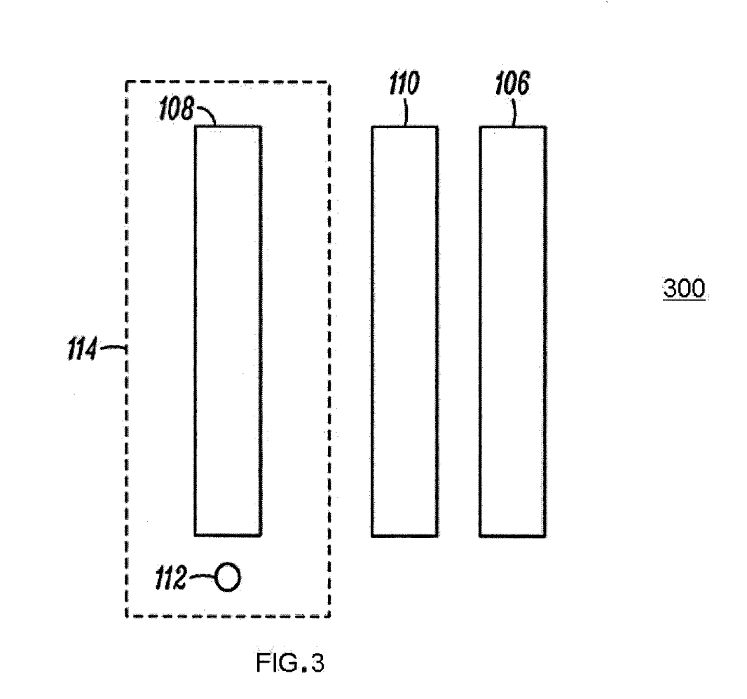

FIG. 4 is from the prior art publication US2008002115A1. In this Figure it is disclosed that the mobile electronic device 100 includes a first housing member 102 and a second housing member 104. The first housing member 102 and the second housing member 104 may be made up of materials like metal, plastic, glass and/or hybrids thereof. The first housing member 102 and the second housing member 104 are hingedly connected with one another and are configurable in the open and closed positions.

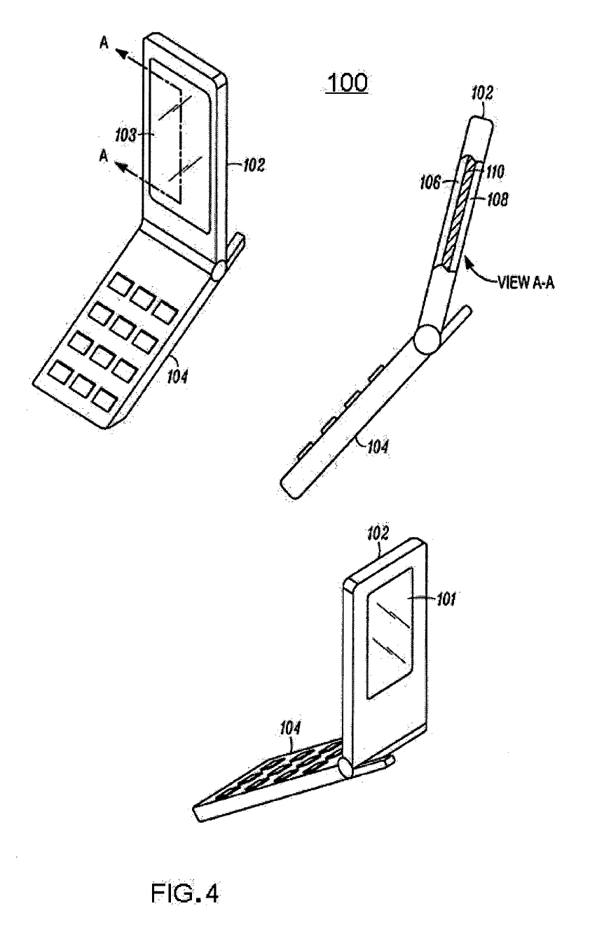

FIG. 5 is from the prior art publication US2008002115A1. This Figure shows the hinged mobile phone disclosed therein in the closed configuration.

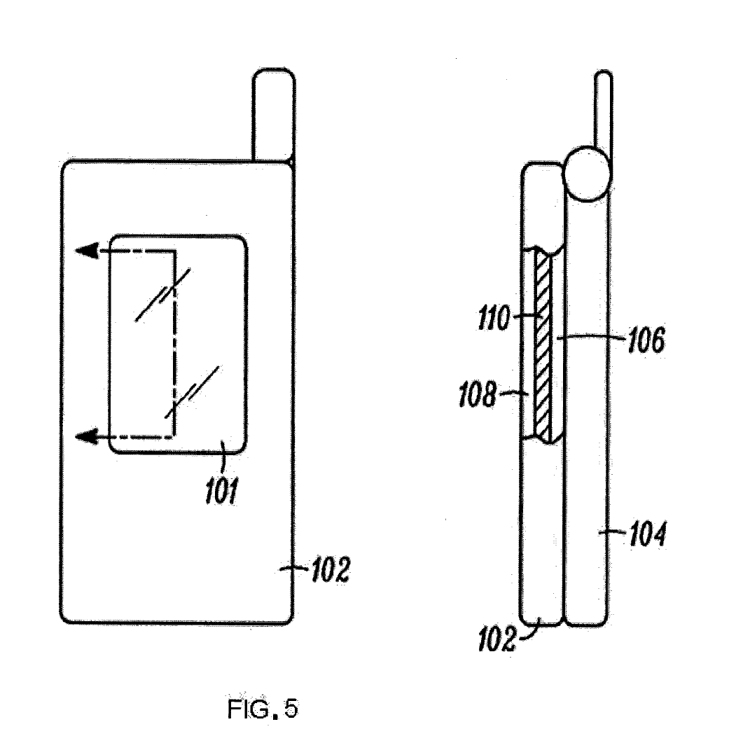

FIG. 6 shows a side view of an example device of the invention. The device may relate to the device of FIG. 2.

FIG. 7 shows the front face and the back face of an example device of the invention in the same Figure. The device is shown in the on state. The device may relate to the device of FIG. 2.

### DETAILED DESCRIPTION

In an example of the invention, there is provided a dual screen bar form factor phone with a bi-stable display. An advantage of a dual screen bar form factor phone is that one screen is always visible, whichever way up the device is placed on a table. By displaying an incoming message on both screens, this ensures that incoming messages are always visible when the device is lying on a table. The first display screen may use electrowetting technology. The second display screen may use electrowetting technology eg. Liquavista.

The device appearance may be context-related eg. in relation to position such as one determined using a global positioning system (GPS) receiver, or in relation to weather, or in relation to temperature, or in relation to time of day. Context related (eg. position-related) device appearance may include location-based advertising. Context related (eg. position-related) device appearance may include results of a location-based search.

Notification and customization are important tasks in mobile computing. For notification it is known to use sound, vibration or LCD/AMOLED (liquid crystal display/Active-matrix organic light-emitting diode) displays. All those ways provide notification for a limited time and cannot work in always-on mode due to high power consumption. There are cases with segmented bi-stable displays used for notifications, but they don't give right flexibility with notification messages or/and options.

There are many ways for customization of the device—pictures and themes for user interface (UI) on main screen, sounds and different accessories like phone cases can be used to change the look of the device. The look of the device can be changed by changing what is displayed on the bi-stable screen, such as to give the appearance of a different phone case for example. For example, the phone skin can be changed. The phone skin may be one or more of wallpaper, photos, movies, user-customized content.

In an example of the invention, there is provided a bi-stable active matrix and high-resolution display on the back panel of the device. This improvement gives the following advantages in relation to prior art cases:
Phone customization—user is able to display any pattern, picture or application interface to differentiate their phone from others
Notifications—any application or service is able to display the notification on the back screen. Notification time is not limited, because a bi-stable display is used.
Notifications—any application or service is able to display the notification on the front screen. The notification such as a message may be provided on the front screen and on the back screen.
The information remains on the screen even when the phone itself is switched off. This is important even for manufacturing—a manufacturer can place all needed information directly on the bi-stable screen: eg. serial number, certification logos, country of origin and so on.

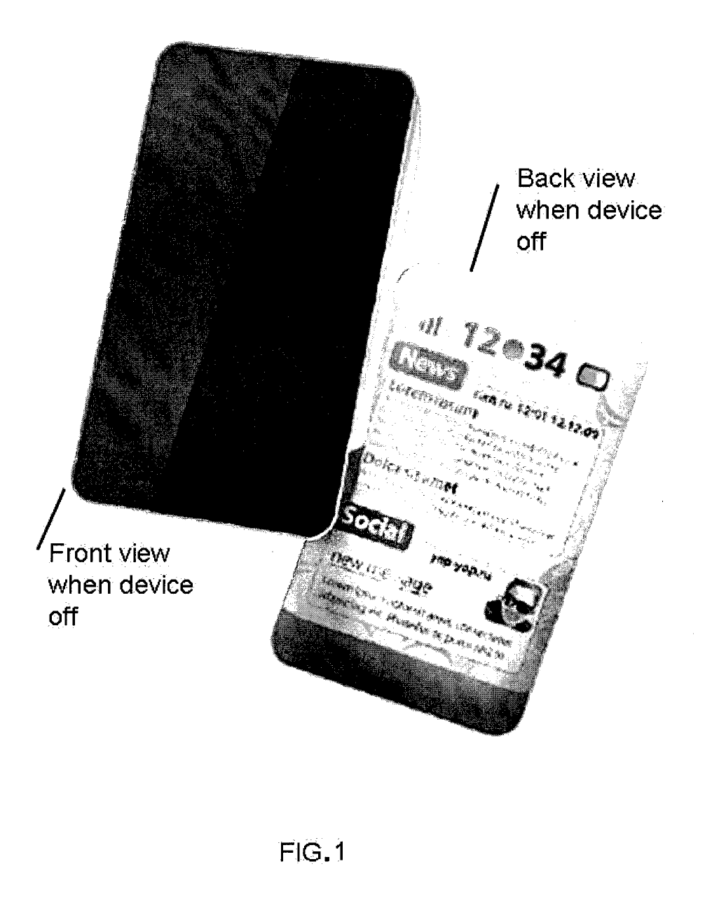

An example of the invention is shown in FIG. 1. FIG. 1 shows the front face and back face of an example device of the invention in the same Figure. The device is shown in the off state. In the off state, the front face is not illuminated: it is shown as dark. However, in the off-state, the bi-stable display on the back face continues to display content, which can be viewed as a result of external illumination eg. ambient illumination. In an example of FIG. 1, the front face has an AMOLED display, and the back face has an E-ink bi-stable display.

A bi-stable display may use interferometric modulation technology eg. Qualcomm Mirasol.

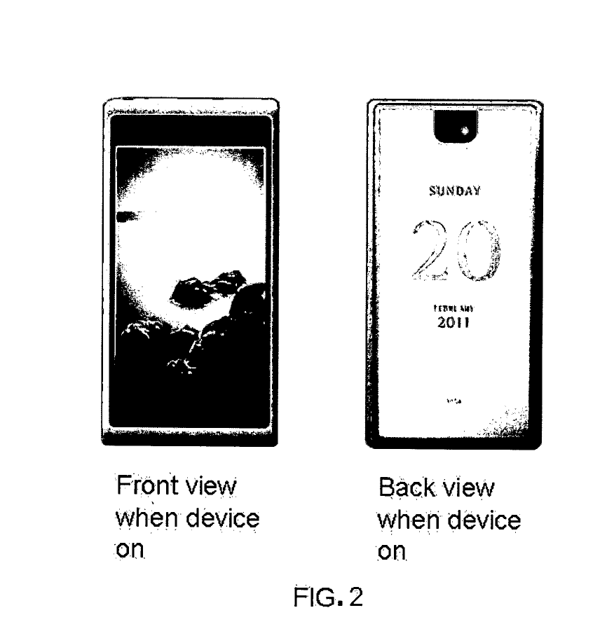

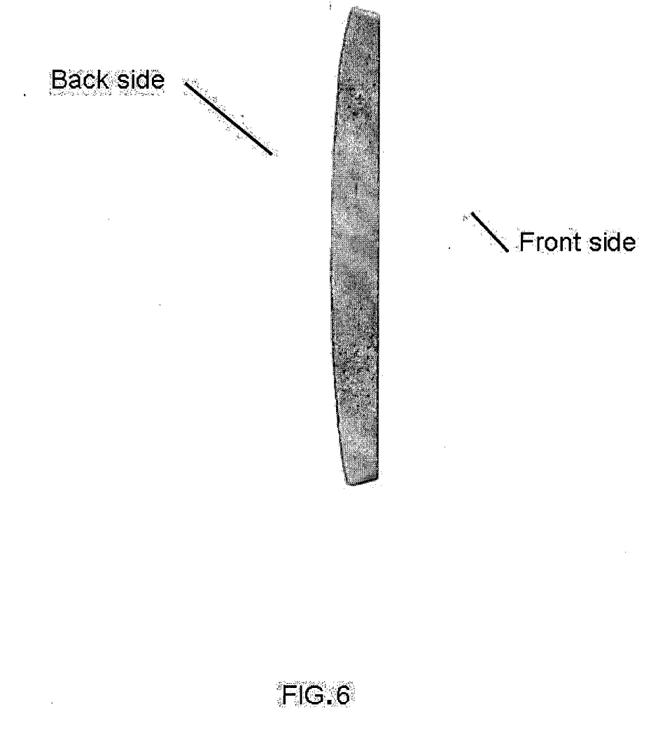

An example of the invention is shown in FIG. 2. FIG. 2 shows the front face and the back face of an example device of the invention in the same Figure. The device is shown in the on state. In the on state, the front face is illuminated and can display an image or other content. In the on-state, the bi-stable display on the back face also can display an image or other content. In an example of FIG. 2, the front face has an AMOLED display, and the back face has an E-ink bi-stable display. FIG. 6 shows a side view of an example of the invention of FIG. 2.

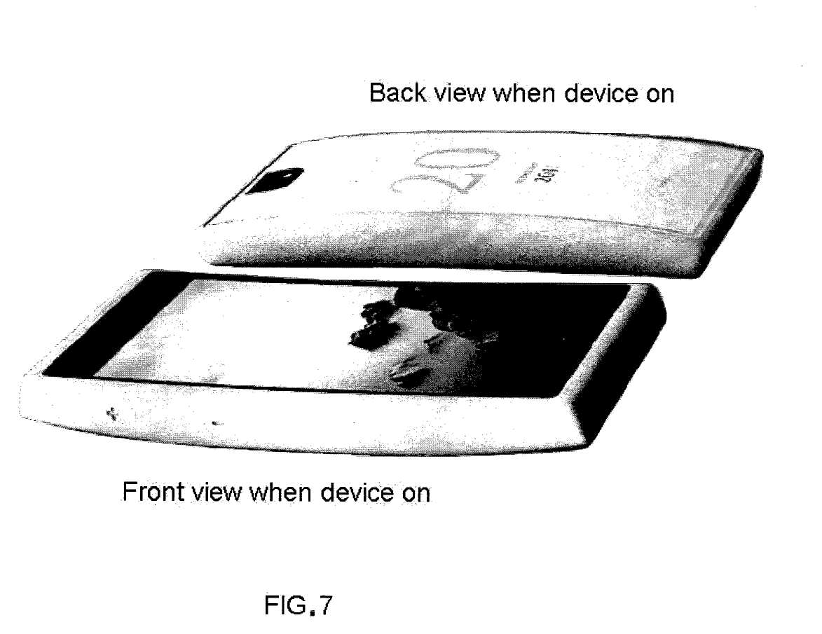

An example of the invention is shown in FIG. 7. FIG. 7 shows the front face and the back face of an example device of the invention in the same Figure. The device is shown in the on state. In the on state, the front face is illuminated and can display an image or other content. In the on-state, the bi-stable display on the back face also can display an image or other content. In an example of FIG. 7, the front face has an AMOLED display, and the back face has an E-ink bi-stable display.

An example of the front display is: 4″ WVGA (800×480 Or 854×480)

Technology: AMOLED or sIPS/FFS

Nissha Capacitive touch screen

Glass: Gorilla Glass (Corning)

An example of the back screen is: Electronic Paper Display under glass on back side (E-INK).

Properties of the back face may include:
E-INK Back screen
Sharp Greyscale panel
Perceived as part of case
Low power consumption

Properties of the back screen may include:

1. Image
Resolution: 700˜900×480 (possible target: similar to front display)
Colors: 16 Grey scale (E-ink) or 65K (LG)
Contrast: 10:1˜20:1, Reflective ratio: 40%+
Refresh ratio: 150 ms˜400 ms
Ability to refresh any area starting from 1 pixel
Color scheme conforms to case color

2. Power Consumption
Approximately 1000 full screen updates using 300 mAh of charge
To minimize power consumption, update rate should be minimized to the order of twice per minute
Does not consume/require power when in bi-stable state

The back screen output may provide:
Interactions,
Control,
Use cases,
Personalization,
Widgets,
Privacy

An example of interactions is text messages from a blog site. An example of control is varying the frequency of back screen updates eg. from once per minute to once per 5 minutes. An example of use cases is receipt of a major emergency notification by an emergency services worker. An example of personalization is putting a photo of a favourite landmark on the back screen. An example of privacy is removing names of companies or individuals from any received incoming message displayed on the back screen.

A bar form factor display device may be one wherein the back display screen output provides a social network screen.

Preinstalled Widgets may include: Clock, Social aggregator, Communications Log, “Favorites” Bucket, News, Weather, Yota Connection, Battery, Contacts Favorites, Latitude & Longitude, and Player.

The Back Screen may provide:
Context related Themes (Weather, Location, Environment)
Widgets, Notifications
Personalization
Post cards
Operator Push (Congratulations, Customer info)

The back display of the device may display news provided by a news service. The back display of the device may display social messages provided by a social messaging service. The back display of the device may display output providing social aggregator output or social network output. The social aggregator output or social network output may be a Facebook page. The back display of the device may display a Google search page. The back display of the device may display an indication of mobile phone signal strength. The back display of the device may display an indication of battery charge state. The back display of the device may display calendar information.

The back display of the device may be the only operational display of the device when the device operates in a low power notification mode. When the device operates in a low power notification mode the back display of the device may be updated in response to an incoming news story provided by a news service. When the device operates in a low power notification mode the back display of the device may be updated in response to an incoming social message provided by a social messaging service. The device may be programmed such that when the device operates in a low power notification mode, the back display of the device displays content updates of one or more categories, for example, news, social messages, an emergency notification, financial news, earthquake, tsunami or weather. The categories may be preselected, such as by a user or by a network services provider.

Further Aspects of the Device

The device may be portable. The device may be a mobile phone, a portable digital assistant, a laptop, a digital audio player or a tablet computer. Known digital audio players include the ipod and mp3 players. Known tablet computers include the ipad. The device may include a virtual keyboard. The device may have a touch screen. The device may have two screens each of which is a touch screen. The bi-stable screen may be a touch screen. A screen that is not a bi-stable screen may be a touch screen. The device may include a second bi-stable screen. The device may include a second bi-stable screen which is a touch screen. The device may include a second bi-stable screen which is not a touch screen.

The bi-stable screen may occupy greater than 50% of the area of the major face of the device on which it is located. The bi-stable screen may occupy greater than 60% of the area of the major face of the device on which it is located. The bi-stable screen may occupy greater than 70% of the area of the major face of the device on which it is located. The bi-stable screen may occupy greater than 80% of the area of the major face of the device on which it is located. The bi-stable screen may occupy greater than 90% of the area of the major face of the device on which it is located. The bi-stable screen may occupy greater than 95% of the area of the major face of the device on which it is located.

The screen other than the bi-stable screen may occupy greater than 50% of the area of the major face of the device on which it is located. The screen other than the bi-stable screen may occupy greater than 60% of the area of the major face of the device on which it is located. The screen other than the bi-stable screen may occupy greater than 70% of the area of the major face of the device on which it is located. The screen other than the bi-stable screen may occupy greater than 80% of the area of the major face of the device on which it is located. The screen other than the bi-stable screen may occupy greater than 90% of the area of the major face of the device on which it is located. The screen other than the bi-stable screen may occupy greater than 95% of the area of the major face of the device on which it is located.

A second bi-stable screen may occupy greater than 50% of the area of the major face of the device on which it is located. A second bi-stable screen may occupy greater than 60% of the area of the major face of the device on which it is located. A second bi-stable screen may occupy greater than 70% of the area of the major face of the device on which it is located. A second bi-stable screen may occupy greater than 80% of the area of the major face of the device on which it is located. A second bi-stable screen may occupy greater than 90% of the area of the major face of the device on which it is located. A second bi-stable screen may occupy greater than 95% of the area of the major face of the device on which it is located.

The device may comprise a single backlight module situated between its two major faces. The backlight module may illuminate one display on one major face. The backlight module may illuminate two displays each of which is situated on a different major face of the device to the other display.

The device may comprise two backlight modules, each of which may illuminate a display situated on a major face of the device. Each backlight module may illuminate a respective display on a respective major face of the device. The two backlight modules may be situated between two displays of the device, where each display is situated on a different major face of the device to the other display.

Curved Bar Form Factor Display Device (eg. Phone)

The bar form factor display device (eg. a phone) may have a unique and organic shape—essential for rapid product differentiation in a crowded space. Examples are shown in FIGS. 6 and 7. The bar form factor display device may have a concave front face and a convex rear face. The magnitude of the curvature of the faces may be the same or similar. The concave front may match the path of a finger as the user's wrist rotates. Hence it's very natural to use. Having a curved surface as the vibrating distributed mode loudspeaker (DML) speaker is also better since if the front display with the speaker exciters was instead a flat surface, then it would sound unpleasant if that flat surface is placed down against a tabletop. Curving the surface prevents this happening. Preferred curvature of front and back is cylindrical, but spherical or aspherical are possible. The convex back can have a bistable display. Since the normal resting position is front face down, the back screen with bi-stable display is normally displayed when bar form factor display device is in the resting position. This resting position is mechanically stable. If bar form factor display device is placed back down (ie convex face down), the bar form factor display device could spin, which is unstable. Hence a user will likely place bar form factor display device front face (i.e. concave face) down, with the bi-stable screen showing.

If the bar form factor display device is in a pocket, the front face (concave face) can face inwards, since this better matches leg curvature. This can be the better configuration (as opposed to front face up) for antenna reception.

In manufacturing, the curved shape may be laminated to glass.

DML Bar Form Factor Display Device (eg. Phone) Speaker

It's hard to get good quality audio performance, unless you have a large speaker with a large and ugly speaker hole. In one example, we use NXT plc distributed mode loudspeaker (DML) technology here to vibrate the entire bar form factor display device (eg. phone) screen—the whole screen surface acts as the speaker. The speaker hole can be fully eliminated. One can use two small drivers/exciters under the glass to make the screen vibrate. DML has never been used before to drive a screen surface in a mobile phone or a bar form factor display device. Haptic feedback can be provided by the drivers too—a new use for the DML exciters.

Device audio properties may be characterized by:

On-board Audio: 128-Voice Polyphony,

QconcertPlus, Dolby 5.1 Surround,

Echo and Noise Cancellation.

Additional ANC (Audience).

2 Microphones.

NXT display surface sound (No speakers)

Deep stereo Surface Sound

No conventional speakers

Adaptive Noise Cancellation

The case and materials may be characterized by:

Case: Single block

Materials: Plastic or Texin™

A hinged (eg. clam shell) phone may be provided which includes, in addition to a main display which is concealed when the phone is in a closed configuration, two bi-stable displays, one on each major face of the phone when the device is in a closed configuration. This ensures that even when the device is in a closed configuration, received messages may be displayed on both bistable screens so that the received messages are visible to a user even when the phone is in the closed configuration, irrespective of which major face is facing upwards when the device is lying on a surface such as a table surface.

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred example(s) of the invention, it will be apparent to those of ordinary skill in the art that numerous modifications can be made without departing from the principles and concepts of the invention as set forth herein.

Concepts

There are multiple concepts, described as concepts ‘A-B’, in this disclosure. The following may be helpful in defining these concepts.

A. Bar Form Factor Display Device

There is provided a bar form factor display device comprising front and back major faces, the front major face arranged to present a first display screen and the back major face arranged to present a second display screen different to the first display screen.

The first display screen may be called the front display screen. The second display screen may be called the back display screen. The above may include additionally any of the following, alone or in combination:
the second display screen uses electrowetting technology.
the second display screen is a bi-stable display screen.
Bar form factor display device is a slate device.
Bar form factor display device is a bar or candybar device.
Bar form factor display device is a slab-shaped form.
Bar form factor display device displays an image in the off state.
Bar form factor display device displays an image in a low power notification mode.
Bar form factor display device displays an image on the bi-stable display in the off state or in a low power notification mode.
Bar form factor display device first display screen is a liquid crystal display screen.
Bar form factor display device first display screen is an active-matrix organic light-emitting diode display screen.
Device appearance is context related.
Context related device appearance includes location-based advertising
Context related device appearance includes results of a location-based search.
The look of the device can be changed by changing what is displayed on the bi-stable screen.
The device skin can be changed.
The device skin is one or more of wallpaper, photos, movies, user-customized content.
The look of the device can be changed by changing what is displayed on the bi-stable screen to give the appearance of a different phone case.
There is provided a bi-stable active matrix and high-resolution display on the back panel of the device.
Regarding the back panel, user is able to display a pattern, picture or application interface to differentiate their phone from others.
any application or service executing on the device is able to display a notification on the back screen.
Notification time is not limited, because a bi-stable display is used.
The information remains on the back screen even when the phone itself is switched off.
in the off-state, the bi-stable display on the back face continues to display content, which can be viewed using external illumination.
the back face has an E-ink bi-stable display.
the front face has an AMOLED display, and the back face has an E-ink bi-stable display.
In the on state, the front face is back-illuminated and can display an image or other content; in the on-state, the bi-stable display on the back face also can display an image or other content.
front display is touch screen.
back screen is: Electronic Paper Display under glass.
back screen is: Grayscale panel.
back screen is: interferometric modulation technology panel.
back face is: perceived as part of case.
back face has low power consumption.
back screen resolution is similar to front display resolution.
back screen provides approximately at least 1000 full screen updates using 300 mAh of charge for a screen size of approximately 4 inches.
back screen update rate is the order of twice per minute.
back screen does not consume power or require power when in bi-stable state.
back screen output provides one or more of: Interactions, Control, Use cases, Personalization, Widgets, Privacy.
back screen output provides Social aggregator output.
back screen output provides Latitude & Longitude eg. those of the device.
back screen output provides Location eg. device location.
back screen output provides Notifications.
back screen output provides Operator Push output.
back screen output provides news provided by a news service.
back screen output provides social messages provided by a social messaging service.
back screen output provides an indication of mobile phone signal strength.
back screen output provides an indication of battery charge state.
back screen output provides calendar information.
back display of the device is the only operational display of the device when the device operates in a low power notification mode.
when the device operates in a low power notification mode, the back display of the device displays content updates of one or more categories.
when the device operates in a low power notification mode, the back display of the device displays content updates of one or more categories, the categories including one or more of news, social messages, an emergency notification, financial news, earthquake, tsunami or weather.
when the device operates in a low power notification mode, the back display of the device displays content updates of one or more categories, wherein the categories are preselected
when the device operates in a low power notification mode, the back display of the device displays content updates of one or more categories, wherein the categories are preselected by a user
when the device operates in a low power notification mode, the back display of the device displays content updates of one or more categories, wherein the categories are preselected by a network services provider.
Bar form factor display device, wherein an application or service executing on the device is able to display a notification on the first screen.
Bar form factor display device, wherein any application or service executing on the device is able to display a notification on the first screen.
Bar form factor display device, wherein a message is provided on first screen and on second screen.
Bar form factor display device, wherein the second display screen output provides a social network screen.
Bar form factor display device, wherein the second display screen output provides social aggregator output or social network output.
Bar form factor display device, wherein the social aggregator output or social network output is a Facebook page.
Bar form factor display device, wherein the second display screen output provides a Google search page.
device is portable.
device is a mobile phone, a portable digital assistant, a laptop, or a tablet computer.
device includes a virtual keyboard.
device has a touch screen.
device has two screens each of which is a touch screen.
bi-stable screen is a touch screen.
bi-stable screen is not a touch screen.
A screen that is not a bi-stable screen is a touch screen.
device includes a second bi-stable screen.
device includes a second bi-stable screen which is a touch screen.
device includes a second bi-stable screen which is not a touch screen.
bi-stable screen occupies greater than 70% of the area of the major face of the device on which it is located.
bi-stable screen occupies greater than 90% of the area of the major face of the device on which it is located.
bi-stable screen occupies greater than 95% of the area of the major face of the device on which it is located.
screen other than the bi-stable screen occupies greater than 70% of the area of the major face of the device on which it is located.
screen other than the bi-stable screen occupies greater than 90% of the area of the major face of the device on which it is located.
screen other than the bi-stable screen occupies greater than 95% of the area of the major face of the device on which it is located.
A second bi-stable screen occupies greater than 70% of the area of the major face of the device on which it is located.
A second bi-stable screen occupies greater than 90% of the area of the major face of the device on which it is located.
A second bi-stable screen occupies greater than 95% of the area of the major face of the device on which it is located.
device comprises a single backlight module situated between its two major faces.
single backlight module illuminates one display on one major face.
single backlight module illuminates two displays each of which is situated on a different major face of the device to the other display
device comprises two backlight modules, each of which illuminates a display situated on a major face of the device
the two backlight modules each illuminates a respective display on a respective major face of the device
The two backlight modules are situated between two displays of the device, where each display is situated on a different major face of the device to the other display.

B. Method of Providing Notification Messages in a Bar Form Factor Display Device at Low Power

Method of providing notification messages on a bar form factor display device operating at low power, the bar form factor display device comprising front and back major faces, the front major face arranged to present a first display screen and the back major face arranged to present a second display screen different to the first display screen, wherein the second display screen is a bi-stable display screen, comprising the steps of:

i) Executing software on the device, the software operating the device in a low power notification mode in which the first display screen is off and in which the device is operable to receive a notification message;

ii) The software on the device receiving a notification message;

iii) Displaying the notification message on the bi-stable display screen.

The first display screen may be called the front display screen. The second display screen may be called the back display screen. The above may include additionally any of the following, alone or in combination:
The software determines if the notification message is a new notification message, and the bi-stable display screen is updated only if the notification message is a new notification message.
notification messages are from a notification message provider.
The software on the device receiving a notification message from a notification message provider.
Displaying the notification message on the bi-stable display screen at a low screen update frequency.
the notification message comprises an image.
the notification message comprises text.
an application or service executing on the device is able to display a notification message on the back screen.
any application or service executing on the device is able to display a notification message on the back screen.
Notification message display time is not limited, because a bi-stable display is used.
Notification message remains on the back screen even when the phone itself is switched off.
the back face has an E-ink bi-stable display.
back screen is: Electronic Paper Display under glass.
back screen uses interferometric modulation display technology.
back screen resolution is similar to front display resolution.
back screen provides approximately at least 1000 full screen updates using 300 mAh of charge for a screen size of approximately 4 inches.
back screen update rate is the order of twice per minute.
Notification message is of one or more categories, the categories including one or more of news, social messages, an emergency notification, financial news, earthquake, tsunami or weather.
Notification message is a social network message provided on a social network screen.
Notification message is a social network message provided on a Facebook page.
Notification message is a social message provided by a social messaging service.
Notification message is a social message provided by a social networking service.
Notification message is of one or more categories, wherein the categories are preselected.
Notification message is of one or more categories, wherein the categories are preselected by a user.
Notification message is of one or more categories, wherein the categories are preselected by a network services provider.
Notification message is text message from a blog site.
Notification message is privacy controlled.
Maximum screen update frequency is a user settable parameter in the software.
device is portable.
the device is a mobile phone, a portable digital assistant, a laptop, a digital audio player (eg. ipod), or a tablet computer (eg. ipad).
device includes a virtual keyboard.
device has a touch screen.
Including the step of changing the skin of the bi-stable display screen.
The step of changing the skin of the bi-stable display screen comprises providing a skin which is one or more of: wallpaper, photos, movies, or user-customized content.
Including the step of providing context-related content on the bi-stable display screen.
The step of providing context-related content on the bi-stable display screen includes providing location-based advertising.
The step of providing context-related content on the bi-stable display screen includes providing results of a location-based search.

1. Method of providing notification messages on a bar form factor display device operating at low power, the bar form factor display device comprising front and back major faces, the front major face arranged to present a first display screen providing a main screen user interface, and the back major face arranged to present a second display screen different to the first display screen, wherein the second display screen is a bi-stable display screen, comprising the steps of:
i) Executing software on the bar form factor display device, the software operating the device in a low power notification mode in which the first display screen on the front major face providing a main screen user interface is off and in which the device is operable to receive a notification message;
ii) The software on the device receiving a notification message from a notification message provider; and
iii) Displaying the notification message on the bi-stable display screen on the back major face of the device, wherein the bi-stable display screen on the back major face of the device is different to the first display screen.

2-4. (canceled)

5. Method of claim 1, wherein the notification message is displayed on the bi-stable display screen at a low screen update frequency.

6-7. (canceled)

8. Method of claim 1, wherein an application or service executing on the device is able to display a notification message on the second screen.

9. Method of claim 1, wherein any application or service executing on the device is able to display a notification message on the second screen.

10-11. (canceled)

12. Method of claim 1, wherein the second screen comprises an E-ink bi-stable display.

13. Method of claim 1, wherein the second screen comprises Electronic Paper Display under glass.

14. Method of claim 1, wherein the second screen uses interferometric modulation display technology.

15. Method of claim 1, wherein a first display screen resolution is similar to a second display screen resolution.

16. Method of claim 1, wherein the second screen provides approximately at least 1000 full screen updates using 300 mAh of charge for a screen size of approximately 4 inches.

17. Method of claim 1, wherein the second screen update rate is the order of twice per minute.

18. Method of claim 1, wherein the notification message is of one or more categories, the categories including one or more of news, social messages, an emergency notification, financial news, earthquake, tsunami or weather.

19. Method of claim 1, wherein a notification message is a social message provided by a social networking service.

20. Method of claim 19, wherein the social networking service is Facebook.

21. Method of claim 1, wherein a notification message is a social message provided by a social messaging service.

22. (canceled)

23. Method of claim 1, wherein the notification message is of one or more categories, wherein the categories are preselected.

24. Method of claim 23, wherein the categories are preselected by a user.

25. Method of claim 23, wherein the categories are preselected by a network services provider.

26. Method of claim 1, wherein the notification message is text message from a blog site.

27. Method of claim 1, wherein the notification message is privacy controlled.

28. Method of claim 1, wherein maximum screen update frequency is a user settable parameter in the software.

29. (canceled)

30. Method of claim 1, wherein the device is a mobile phone, a portable digital assistant, a digital audio player (eg. ipod), or a tablet computer (eg. ipad).

31. (canceled)

32. Method of claim 1, wherein the device comprises a touch screen.

33. Method of claim 1, including the step of changing the skin of the bi-stable display screen.

34. Method of claim 33, wherein the step of changing the skin of the bi-stable display screen comprises providing a skin which is one or more of: wallpaper, photos, movies, or user-customized content.

35. Method of claim 1, including the step of providing context-related content on the bi-stable display screen.

36-37. (canceled)

38. Computer program product embodied on a non-transitory computer readable medium, operable to provide notification messages on a bar form factor display device operating at low power, the bar form factor display device comprising front and back major faces, the front major face arranged to present a first display screen providing a main screen user interface and the back major face arranged to present a second display screen different to the first display screen, wherein the second display screen is a bi-stable display screen, the computer program product when running on the bar form factor display device configured to provide the steps of:
i) The computer program product operating the device in a low power notification mode in which the first display screen on the front major face providing a main screen user interface is off and in which the device is operable to receive a notification message;
ii) The computer program product on the device receiving a notification message from a notification message provider; and
iii) The computer program product displaying the notification message on the bi-stable display screen on the back major face of the device, wherein the bi-stable display screen on the back major face of the device is different to the first display screen.

39. Method of claim 1, wherein the bar form factor display device is a smartphone.

40. Method of claim 2, wherein the bar form factor display device is a smartphone in that it is a phone with more advanced computing capability and connectivity than a feature phone.

41. Method of claim 1, wherein the bar form factor display device includes a web browser viewable from the first display screen.

42. Method of claim 1, wherein the bar form factor display device comprises software including a plurality of applications operable to execute on the device.

43. Method of claim 1, wherein the bi-stable screen occupies greater than 70% of the area of the major face of the device on which it is located.
